(19) United States
(12) Patent Application Publication
(10) Pub. No.: US 2014/0102326 A1
(43) Pub. Date: Apr. 17, 2014

(54) PRINTING PRESS INCLUDING BOWED AXIS ROLLERS AND METHOD OF PRINTING

(71) Applicant: Goss International Americas, Inc., Durham, NH (US)

(72) Inventors: James Brian Vrotacoe, Barington, NH (US); Daniel Paul Gagne, South Berwick, ME (US); Michael Robert Lemelin, Madbury, NH (US)

(21) Appl. No.: 13/914,000

(22) Filed: Jun. 10, 2013

Related U.S. Application Data
(60) Provisional application No. 61/713,297, filed on Oct. 12, 2012.

(51) Int. Cl. B41F 3/56

(52) U.S. Cl. CPC B41F 3/56
USPC 101/219; 101/483

(57) ABSTRACT

A printing press is provided. The printing press includes a first printing unit including a first plate cylinder, a first blanket cylinder and a first impression cylinder forming a first printing nip with the first blanket cylinder, a first bowed roller upstream of the first printing unit spreading a web before the web enters the first printing nip, a second printing unit downstream of the first printing unit including a second plate cylinder, a second blanket cylinder and a second impression cylinder forming a second printing nip with the second blanket cylinder, and a second bowed roller between the first printing and the second printing unit, the second bowed roller spreading the web before the web enters the second printing nip. A method printing is also provided.

Priority is hereby claimed to U.S. Provisional Patent Application No. 61/713,297 filed on Oct. 12, 2012, the entire disclosure of which is hereby incorporated by reference herein.

The present invention relates generally to printing presses and more specifically to a registration control in a printing press.

### BACKGROUND

U.S. Pat. No. 4,404,906 discloses using a bowed roller solely upstream of a first printing unit to expand a web laterally to counteract web fan-out from water absorption. Bowed rollers are intentionally not used upstream of the printing units other than the first printing unit. Instead, straight axis idler rollers are used upstream of the other printing units. The web is wrapped around the bowed roller at a wrap angle of between 60° and 180°.

### SUMMARY OF THE INVENTION

A printing press is provided. The printing press includes a first printing unit including a first plate cylinder, a first blanket cylinder and a first impression cylinder forming a first printing nip with the first blanket cylinder, a first bowed roller upstream of the first printing unit spreading a web before the web enters the first printing nip, a second printing unit downstream of the first printing unit including a second plate cylinder, a second blanket cylinder and a second impression cylinder forming a second printing nip with the second blanket cylinder, and a second bowed roller between the first printing and the second printing unit, the second bowed roller spreading the web before the web enters the second printing nip.

A method printing is also provided. The method includes spreading and flattening a plastic film web before passing the plastic film web through a first printing unit and spreading and flattening the plastic film web after the plastic film web exits the first printing unit and before passing the plastic film web through a second printing unit.

### BRIEF DESCRIPTION OF THE DRAWINGS

The present invention is described below by reference to the following drawings, in which:

FIG. 1 shows a schematic side view of a printing press according to an embodiment of the present invention;

FIG. 2 shows a plan view of a bowed roller of the printing press; and

FIG. 3 shows a schematic side view of a printing unit of the printing press.

### DETAILED DESCRIPTION

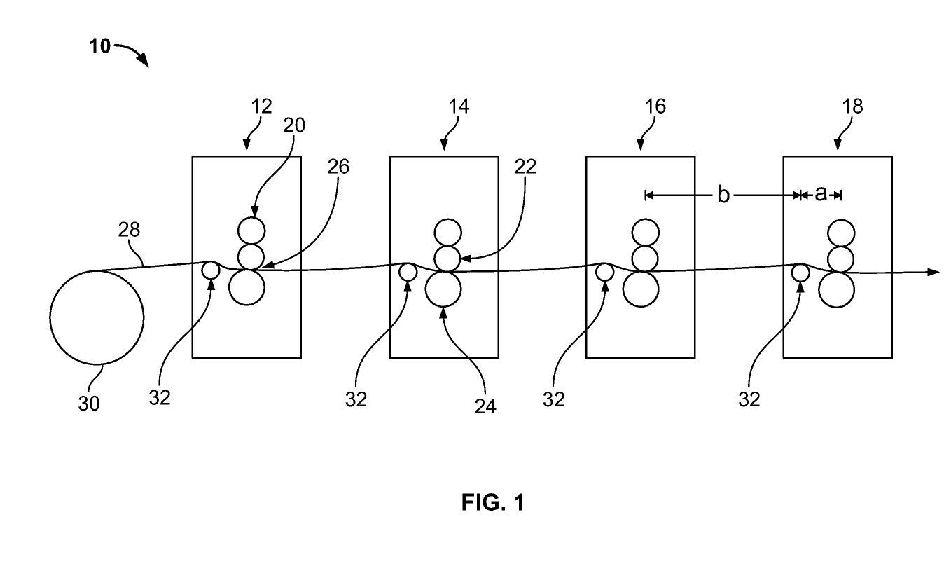

FIG. 1 shows a printing press 10 according to an embodiment of the present invention. Printing press 10 includes a first printing unit 12, a second printing unit 14 downstream of first printing unit 12, a third printing unit 16 downstream of second printing unit 14 and a fourth printing unit 18 downstream of third printing unit 16. In a preferred embodiment, each printing unit 12, 14, 16, 18 is a vertically aligned printing unit including a plate cylinder 20, a blanket cylinder 22 and an impression cylinder 24 forming a printing nip 26 for printing images on one side of a web 28 passing horizontally through printing nip 26. Printing unit 12 is the first upstream printing unit of printing press 10 and receives web 28 from an unwind unit 30. A bowed roller 32 is provided upstream of each printing unit 12, 14, 16, 18 for flattening and spreading web 28 before web 28 enters the respective printing nip 26. Accordingly, one bowed roller 32 is provided between unwind unit 30 and first printing unit 12, one bowed roller 32 is provided between printing units 12, 14, one bowed roller 32 is provided between printing units 14, 16 and one bowed roller 32 is provided between printing units 16, 18. In this embodiment, no other rolls, rollers or web guiding components are provided for contacting web 28 between printing units 12, 14, 16, 18 other than bowed rollers 32 upstream of printing units 14, 16, 18 and bowed rollers 32 only contact the non-printed side of web 28, preventing the smearing of ink on the printed side of web 28. In a preferred embodiment, web 28 is a plastic film, which may be formed of for example polyethylene terephthalate film or oriented polypropylene film.

In this embodiment, printing press 10 is a four color printing press, with first printing unit 12 including an inking unit supplying black ink and printing black ink on web 28, second printing unit 14 including an inking unit supplying yellow ink and printing yellow ink on web 28, third printing unit 16 including an inking unit supplying magenta ink and printing magenta ink on web 28 and fourth printing unit 18 including an inking unit supplying cyan ink and printing cyan ink on web 28. In other embodiments, the order of the ink may be varied or different colors of inks may be applied. Also, printing press 10 may include more or less than four printing units.

As web 28 passes over each bowed roller 32 at a wrap angle 0, bowed roller 32 spreads and flattens web 28. It has been discovered that providing a bowed roller 32 upstream of each printing unit 12, 14, 16, 18 to consistently spread and flatten web 28 prior to printing with multiple printing units is key to good registration and blur free printing. U.S. Pat. No. 4,404,906 discloses that fan-out is caused solely at the first printing unit by corrugation or fluting experienced by web as the web leaves the feed roll, and that after the first color is printed on the web, the web is no longer corrugated. It has been discovered that this is not the case where the web speed of the printing press is varied between print jobs or during a print job. When such web speed variations occur, particularly when using thin plastic films of for example between 0.5 and 1.1 mils thick, fluting or corrugation is experienced between each printing unit, causing lateral registration problems and blurring. Printing at high web speeds has caused downstream printing units to print wide due to web fan-in, and the print grows wider with increasing web speeds. This is typically the opposite to web fan-out. Providing a bowed roller 32 upstream of each printing unit 12, 14, 16, 18 allows web 28 to be stable and axially tensioned as web 28 passes through each printing unit 12, 14, 16, 18. This helps to maintain the lateral registration of web 28 for each printing unit 12, 14, 16, 18 for a broad range of web speeds and helps prevent blurring, particularly when web 28 is a plastic film web formed of for example polyethylene terephthalate film or oriented polypropylene film and the plastic film web is printed with higher tack ink. Higher tack ink as used herein is an ink having a tack of approximately 14 to 16, as measurement by an inkometer. An example of a high tack ink is 7600/7800 Duracure ink. The high ink tack, together with thin films and lower web tensions, causes the web to follow the blankets according to the heavier ink coverage areas. This is already non-uniform because the images are rarely perfectly consistent and the uneven web follow causes the web to form out of plane troughs. These out of plane troughs can also change with press speed and are the cause of the misregistration and blurred images between printing units.

In a preferred embodiment, each bowed roller 32 is positioned the same distance a upstream of the respective printing unit 12, 14, 16, 18. Accordingly, the distance a between the first bowed roller 32 and the first printing nip 26 of printing unit 12, the distance a between the second bowed roller 32 and the second printing nip 26 of printing unit 14, the distance a between the third bowed roller 32 and the third printing nip 26 of printing unit 16 and the distance a between the fourth bowed roller 32 and the fourth printing nip 26 of printing unit 18 are all equal. Also, in a preferred embodiment, each bowed roller 32 is positioned the same distance b downstream of the previous printing unit 12, 14, 16. Accordingly, the distance b between the second bowed roller 32 and the first printing nip 26 of printing unit 12, the distance b between the third bowed roller 32 and the second printing nip 26 of printing unit 14 and the distance b between the fourth bowed roller 32 and the third printing nip 26 of printing unit 16 are all equal.

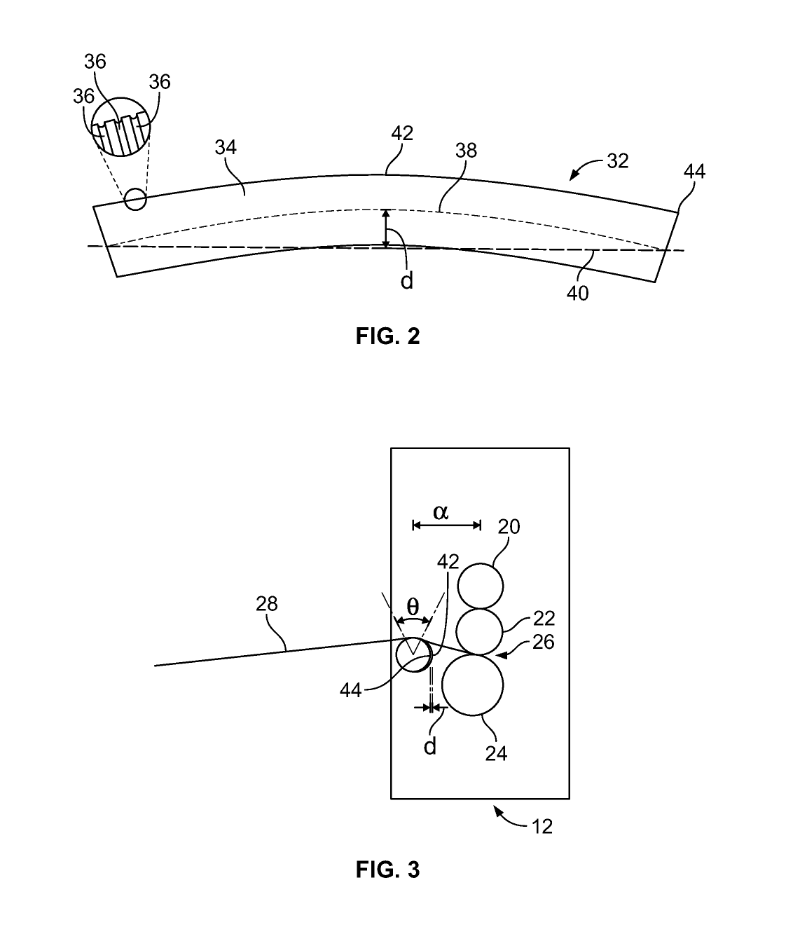

FIG. 2 shows an embodiment of one of bowed rollers 32. As shown in FIG. 2, each bowed roller 32 may have an outer surface formed of an elastomeric covering 34 and may include a plurality of circumferentially aligned grooves 36 formed therein. Grooves 36 may help prevent air entrapment at higher speeds of web 28. In alternative embodiments, other groove patterns may be provided elastomeric covering 34, for example axial or spiral grooves. As used herein, the term “bowed roller” refers to a roller having a central axis 38 that is bowed with respect to a straight axis 40 passing through the centers of the ends of roller 32. In preferred embodiments of the present invention, bowed rollers 32 are bowed such that a distance d between central axis 38 and straight axis 40 is between 0.05 and 0.4 inches at a peak 42 in the axial middle of bowed roller 32. Such bowing causes peak 42 to protrude radially distance d past a front side edge 44. Accordingly, bowed rollers 32 are considered as being bowed by distance d, which is between 0.05 and 0.4 inches in preferred embodiments. In one preferred embodiment, bowed rollers 32 may be bowed by a distance d of 0.12 inches.

FIG. 3 shows an embodiment of printing unit 12, which is configured in substantially the same manner as printing units 14, 16, 18, the only difference being the color of ink being printed. FIG. 3 illustrates the wrap angle θ of web 28 around the upper surface of bowed roller 32. Unlike the 60° and 180° wrap angles of U.S. Pat. No. 4,404,906, in preferred embodiments of the present invention, wrap angle θ is between 5° and 45° for each bowed roller 32 to effectively prevent images printed by printing units 12, 14, 16, 18 from being misaligned with respect to each other. In one preferred embodiment, the wrap angle θ of bowed roll 32 is the same for each printing unit 12, 14, 16, 18. FIG. 3 shows peak 42 of bowed roller 32 protruding toward printing unit 12 in the direction web 28 travels past a front side edge 44 by distance d.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A printing press comprising:
a first printing unit including a first plate cylinder, a first blanket cylinder and an impression cylinder forming a first printing nip with the first blanket cylinder;
a first bowed roller upstream of the first printing unit spreading a web before the web enters the first printing nip;
a second printing unit downstream of the first printing unit including a second plate cylinder, a second blanket cylinder and a second impression cylinder forming a second printing nip with the second blanket cylinder; and
a second bowed roller between the first printing and the second printing unit, the second bowed roller spreading the web before the web enters the second printing nip.

2. The printing press as recited in claim 1 wherein the first bowed roller and the second bower roller are arranged such that the web passes over the first bowed roller with a wrap angle of between 5° and 45° and passes over the second bowed roller with a wrap angle of between 5° and 45°.

3. The printing press as recited in claim 1 wherein the first bowed roller and the second bower roller are arranged such that the web passes over the first bowed roller and the second bowed roller with the same wrap angle.

4. The printing press as recited in claim 1 wherein a distance between the first bowed roller and the first printing nip is equal to a distance between the second bowed roller and the second printing nip.

5. The printing press as recited in claim 1 further comprising:
a third printing unit downstream of the second printing unit including a third plate cylinder, a third blanket cylinder and a third impression cylinder forming a third printing nip with the third blanket cylinder; and
a third bowed roller between the second printing unit and the third printing unit, the third bowed roller spreading the web before the web enters the third printing nip.

6. The printing press as recited in claim 5 wherein the third bowed roller is arranged such that the web passes over the third bowed roller with a wrap angle of between 0° and 45°.

7. The printing press as recited in claim 5 further comprising:
a fourth printing unit downstream of the third printing unit including a fourth plate cylinder, a fourth blanket cylinder and a fourth impression cylinder forming a fourth printing nip with the fourth blanket cylinder; and
a fourth bowed roller between the second printing unit and the fourth printing unit, the fourth bowed roller spreading the web before the web enters the fourth printing nip.

8. The printing press as recited in claim 7 wherein the fourth bowed roller is arranged such that the web passes over the fourth bowed roller with a wrap angle of between 0° and 45°.

9. The printing press as recited in claim 7 wherein a distance between the first bowed roller and the first printing nip, a distance between the second bowed roller and the second printing nip, a distance between the third bowed roller and the third printing nip and a distance between the fourth bowed roller and the fourth printing nip are all equal.

10. The printing press as recited in claim 9 wherein a distance between the second bowed roller and the first printing nip, a distance between the third bowed roller and the second printing nip and a distance between the fourth bowed roller and the third printing nip are all equal.

11. The printing press as recited in claim 1 wherein the first and second bowed rollers each include an elastomeric covering having grooves formed therein.

12. The printing press as recited in claim 1 wherein the web is a plastic film.

13. A method of printing comprising:
spreading and flattening a plastic film web before passing the plastic film web through a first printing unit; and
spreading and flattening the plastic film web after the plastic film web exits the first printing unit and before passing the plastic film web through a second printing unit.

14. The method as recited in claim 13 wherein the spreading and flattening the plastic film web before passing the plastic film web through the first printing unit is performed by wrapping the plastic film web around a first bowed roller and the spreading and flattening the plastic film web after the plastic film web exits the first printing unit and before passing the plastic film web through the second printing unit is performed by wrapping the plastic film web around a second bowed roller.

15. The method as recited in claim 14 wherein the first bowed roller and the second bower roller are arranged such that the plastic film web passes over the first bowed roller with a wrap angle of between 0° and 45° and passes over the second bowed roller with a wrap angle of between 0° and 45°.

16. The method as recited in claim 14 wherein the first bowed roller and the second bower roller are arranged such that the plastic film web passes over the first bowed roller and the second bowed roller with the same wrap angle.

17. The method as recited in claim 14 wherein a distance between the first bowed roller and a nip of the first printing unit is equal to a distance between the second bowed roller and a nip of the second printing unit.

18. The method as recited in claim 13 wherein the plastic film web is polyethylene terephthalate film or oriented polypropylene film.

19. The method as recited in claim 13 wherein ink printed on the plastic film web is higher tack ink.
